(19) United States
(12) Patent Application Publication
(10) Pub. No.: US 2009/0115257 A1
(43) Pub. Date: May 7, 2009

(54) SWITCHBOARD APPARATUS AND METHOD

(76) Inventors: William Robert Letourneau, Plainville, CT (US); Richard Stillwell, Spring, TX (US)

Correspondence Address: General Electric Company;GE Global Patent Operation, PO Box 861, 2 Corporate Drive, Suite 648, Shelton, CT, 06484, US

(21) Appl. No.: 11/934,375

(22) Filed: Nov. 2, 2007

(51) Int. Cl. H02B 1/20; H02H 3/42

(52) U.S. Cl. 307/126; 307/147; 361/611

(57) ABSTRACT

A switchboard apparatus and method are provided including a switchboard bus with conductors secured to the switchboard apparatus; a power quality meter operatively connected to the switchboard bus to obtain bus voltage and current. The apparatus also includes a capacitor operatively connected to and electrically in-parallel with the switchboard bus; the at least one capacitor further including a switch, the switch configured to open and close so as to connect and disconnect the capacitor operatively connected to the switchboard bus upon the occurrence of predetermined conditions; a controller controls the switch. The capacitor is connected to and disconnected from the switchboard bus as a function of the power factor.

### BACKGROUND OF THE INVENTION

1. Field of the Invention

The present disclosure is related to switchboards. More particularly, the present disclosure is related to switchboards and the efficiency of electric power loads connected thereto.

2. Description of Related Art

Power factor (PF) is the ratio of useful current to total current. It is also the ratio of useful power expressed in kilowatts (KW) to total power expressed in kilovolt-amperes (KVA). Another expression of power factor is the relationship between the phase angle of voltage and resultant current through the loads. The power factor may be calculated as ratio of the cosine of the phase angle between voltage and current which is the same as the ratio between KW (real power) and KVA (apparent power).

Power factor is usually expressed as a decimal or as a percentage. Ideally, the current through the loads is exactly in phase with the generated voltage, having neither a leading phase angle nor lagging phase angle. The phase angle theta is equal to zero ideally, and the corresponding power factor is the cosine of the angle theta where theta is the difference between the current phase angle and the voltage phase angle. Ideally, the cosine of Δ∂ is equal to one. If there is a net inductive load (from lighting, for example), the current phase angle lags the voltage phase angle. In a reactive load, the current phase angle leads the voltage phase angle.

Electric power has two components: Active power or real power, which produces work. Reactive power, which is needed to generate magnetic fields required for operation of inductive electrical equipment, but performs no useful work. Active power is measured in KW. Reactive power is measured in KVAR (Volt-Amperes Reactive). Total power is measured in KVA. The ratio of working power or real power to total power or apparent power is called power factor. Power factor can be corrected or made to substantially equal a desired number through the use of corrective elements, such as a power factor corrective capacitor, connected to an electrical system. A function of power factor corrective capacitors is to increase the power factor by supplying the reactive power when installed at or near inductive electrical equipment. Low-Voltage Power Factor Correction Capacitors, GE Application & Technical Information, GEP-974-G at p. 25.

Typically, electric utilities provide power factor correction in areas where the need has been determined. The use of power factor correction on the customer side is newer and has been expensive and difficult to implement due to cost of equipment, size factors and the lack of commercially available packages for installation at a customer site, with ease.

Accordingly, there is a need for a power factor correction that overcomes, alleviates, and/or mitigates one or more of the aforementioned and other deleterious effects of prior power factor problems or attempts at correction.

### BRIEF SUMMARY OF THE INVENTION

A switchboard apparatus is provided for power factor correction. Lower and upper limits are provided for desired power factor. The exemplary embodiment of the invention determines power factor, compares power factor to the limits and corrects power factor by connecting or disconnecting capacitor load. The capacitor load changes or corrects the power factor. By correcting power factor on a customer side of an electric system, a customer would get less power loss and have less power demand from the power supplier (i.e. electric utility). This could result in cost savings to the customer.

An exemplary embodiment of the present invention provides for a switchboard apparatus. The switchboard apparatus includes a switchboard bus with conductors secured to the switchboard apparatus, a capacitor operatively connected to the switchboard bus and electrically in-parallel with the switchboard bus; and a switch operatively connected between the switchboard bus and the capacitor, the switch configured to open and close the capacitor connection to the switchboard bus. The switchboard apparatus also includes a controller for controlling the switch configured to open and close the capacitor connected to the switchboard bus; and a power quality device operatively connected to the switchboard bus to obtain power quality and provide the power quality to the controller. Wherein the capacitor is connected to and disconnected from the switchboard bus as a function of the power factor.

Another exemplary embodiment of the present invention provides for a switchboard method. The switchboard method is a method of operating a switchboard apparatus on a system including a) providing the switchboard apparatus which includes a switchboard bus with conductors secured to the switchboard apparatus, a capacitor operatively connected to the switchboard bus and electrically in-parallel with the switchboard bus; and a switch operatively connected between the switchboard bus and the capacitor, the switch configured to open and close the capacitor connection to the switchboard bus. The switchboard apparatus also includes a controller for controlling the switch configured to open and close the capacitor connected to the switchboard bus; and a power quality device operatively connected to the switchboard bus to obtain power quality and provide the power quality to the controller. Wherein the capacitor is connected to and disconnected from the switchboard bus as a function of the power factor. The method is further performed by b) providing a first predetermined power factor limit as a lower limit for the power factor of the system; c) providing a second predetermined power factor limit as an upper limit for the power factor of the system; d) determining the power factor of the system; e) comparing the power factor of the system to the first predetermined power factor limit and the second predetermined power factor limit; f) connecting a capacitor, using the switch configured to open and close and hence connect the capacitor to the system, if the power factor of the system is below the first predetermined power factor limit; g) disconnecting, a capacitor, using the switch configured to open and close and hence disconnect the capacitor from the system if the power factor of the system is above the second predetermined power factor limit.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining several embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

Further, the purpose of the foregoing Paragraph Titles used in both the background and the detailed description is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Paragraph Titles are neither intended to define the invention or the application, which only is measured by the claims, nor are they it intended to be limiting as to the scope of the invention in any way.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 illustrates power factor vectors (apparent power, real power and reactive power) and a lagging angle theta;

FIG. 2 illustrates a functional block diagram of an embodiment of the present invention;

FIG. 3 is a logic diagram for another exemplary embodiment of the present invention.

### DETAILED DESCRIPTION OF THE INVENTION

### Power Factor Introduction

Power factor (PF) is the relationship between the phase angle of voltage and resultant current through the loads. Hence, power factor can be calculated as a ratio. Power factor may be referenced herein as power factor, PF, power factor ratio, or PF ratio. The PF ratio is calculated as the cosine of the phase angle between voltage and current, which is the same as the ratio between KW (real power) and KVA (apparent power); see equation (3) below.

[symbol]

=lag between voltage and current (1)

$$PowerFactor or PF = cos ϑ = \frac{real power}{apparent power} = \frac{1 kW}{1 kVA} \qquad ( 2 )$$

Where real power is power that can be used on the load side of a switchboard and apparent power is generated power needed from a supplier, such as an electric utility company.

Solving equation (2) for power factor:

real power=cos [symbol] *apparent power (3)

Solving equation (3) for apparent power:

$$\frac{real power}{cos ϑ} = apparent power \qquad ( 4 )$$

And substituting power factor for cosine theta:

$$\frac{real power}{PF} = apparent power \qquad ( 5 )$$

Ideally, the current through the loads is substantially exactly in phase with the generated voltage, neither leading nor lagging. When the power factor is neither leading, nor lagging, the power factor is equal to one. Equation (2) illustrates the power factor relationship to the phase angle.

In an ideal circumstances with a substantially in phase line and load, power factor of one is obtained when phase angle [symbol] is zero i.e. ∂=0. Hence using the equation (2) above, and solving for power factor, we get PF of one as illustrated in the equation PF=cos [symbol] =cos(0)=1.

Net load is another theoretical explanation of the power factor. The ratio of voltage and current power factors in a theoretically ideal model is one. Hence the ratio equation, where the power factor ratio is PF=1, ideally is:

$$\begin{matrix}\frac{{PF}_{voltage}}{{PF}_{current}} = 1 & ( 6 ) \\ \frac{{PF}_{voltage}}{{PF}_{current}} = \frac{cos {ϑ}_{voltage}}{cos {ϑ}_{current}} = 1 & ( 7 )\end{matrix}$$

Power factor is a unit-less number between 0 and 1. When power factor is equal to 0, the energy flow is substantially all reactive, and stored energy in the load returns to the power source on each cycle. When the power factor is 1, substantially all the energy supplied by the power source is used at the power load. Phase angles are usually stated as leading or lagging to show the sign of the phase angle, where leading is indicated using negative sign.

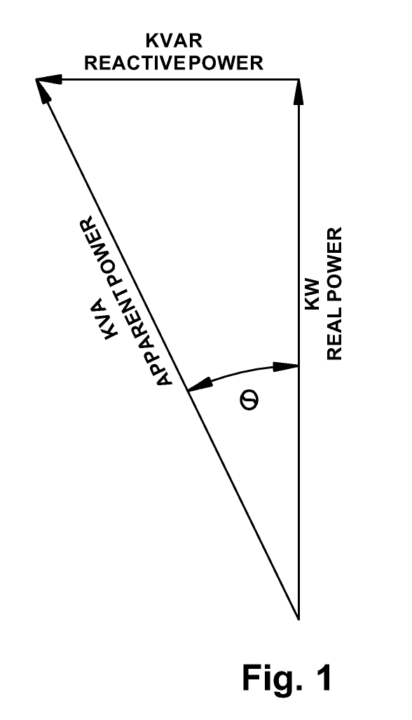

FIG. 1 illustrates power factor vectors (apparent power, real power and reactive power) and a lagging angle theta. In an example, where less than ideal phase angles are present, a net inductive load present at a switchboard, such as a motor switchboard, is calculated. Using equation (3) from above and given 30 degree power lag and 1000 kW apparent power, as illustrated in FIG. 1, we can solve for real power:

real power=cos30*1000w=1154KVA (8)

Where the utility must deliver 1154 kVA of real power to meet the load demands. However, if you correct the power factor to 1, ideally, as in equation (9) below, and solve for real power:

real power=1*1000w=100KVA (9)

Then the utility must deliver only 1000 kVA of real power. The example realizes a 54 kVA real power savings. The correction of the power factor of the load or at the switchboard to a number substantially equal to one is done by providing reactive load i.e. adding capacitors or capacitive load.

In the above example, voltage phase angle lags the current phase angle; the voltage phase angle lag is 30 degrees. Such a lag can commonly occur on an inductive system without power factor correction. The current and voltage are each measured with a sensing device. The sensing devices can be one of various commercially available sensing devices, as may be determined by one of ordinary skill in the art.

Switchboard Apparatus and Method

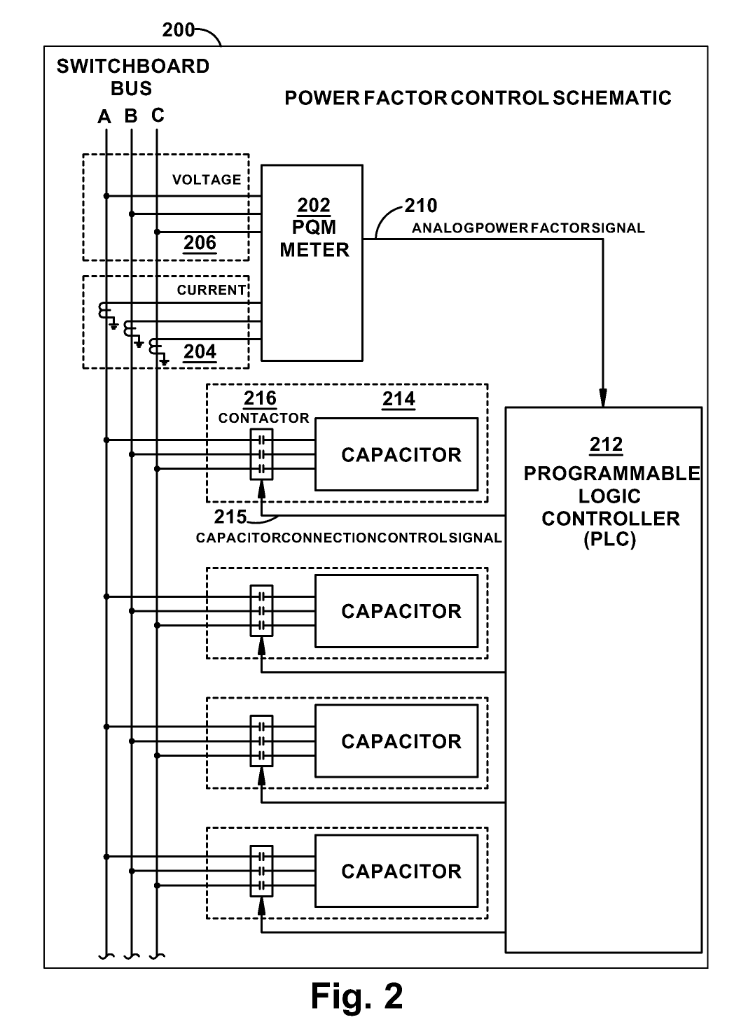

FIG. 2 illustrates a functional block diagram of an embodiment of the present invention. The exemplary embodiment of a switchboard 200 with integrated power factor control circuitry. The power factor control circuitry includes a power quality meter 202 with three-phase current sensor 204 and three-phase voltage sensor 206 at the switchboard bus 208. The PQM provides analog power factor signal 210 to a programmable logic controller (PLC) 212. The PLC 212 can be, for example GE Series One PLC or GE Fanuc 90/30 PLC, which are manufactured and commercially available from General Electric Company of Schenectady, N.Y., the assignee of the present invention. Other PLCs can be used as may be determined by one of ordinary skill in the art. Capacitors 214 each have a three-phase connection to the switchboard bus 208. The capacitors 214 having a three-phase connection to the switchboard bus 208 are each connected in parallel with the switchboard bus 208. A capacitor connection control signal 215 is provided from the PLC 212 to capacitor switches 216. While capacitor switches or contactors 216 are illustrated in the exemplary embodiment of the invention, other electrically controlled switches may be used such as, for example, relay contacts operated by a relay solenoid that is part of the control circuit. Other switches such as electrically controlled switches may be used as determined by one of ordinary skill in the art.

In another exemplary embodiment of the apparatus of the present invention, in place of a PQM, single phase power factor can be obtained using a power factor transducer such as a commercially Scientific Columbus Power Factor Transducer, manufactured by Amtek Power Instruments, Scientific Columbus of Rochester, N.Y. Other measurement device(s) may be used as may be determined by one of ordinary skill in the art.

An embodiment of the switchboard device 200 of the present invention substantially continuously monitors three-phase power factor at a switch board such as a main incoming switchboard, and automatically adds (connects) or drops (disconnects) capacitors in parallel with the main switchboard bus in order to maintain a power factor of substantially one.

A program running on the PLC 212 microprocessor, such as program that corrects power factor to substantially one by adding or dropping capacitors based on this power factor obtained from the measurements via the power quality meter 202. The program that corrects power factor can be provided with the switchboard and PLC, or a similar program can be instituted by a user. The program that corrects power factor can be determined by one of ordinary skill in the art with knowledge of the power factor at an installation site of the switchboard 200. The program is typically in a computer language such as C+, C++, assembly language or other suitable computer language. Alternately the microprocessor could be an application specific integrated circuit (ASIC). The type of microprocessor used in the control circuit could be determined by one of ordinary skill in the art.

In an embodiment of the present invention, illustrated in FIG. 2, the sensing devices (not shown) are included as part of a power quality meter (PQM). The sensing devices (not shown) are a PT and a CT included as part of the power quality meter. The power quality meter can be, for example, a GE PQM commercially available from General Electric Company of Schenectady, New York and the assignee of the present invention. Note that three-phase measurements from the sensing device can be converted into a single representative quantity by using RMS voltage and RMS current as may be determined by one of ordinary skill in the art. Also, the power quality meter may have the ability to output these RMS values; alternately the PLC may convert three-phase inputs to RMS values. In an embodiment of the present invention, the PQM is programmed such that an analog output on the PQM sends a 4-20 mA signal corresponding to three-phase power factor to an analog input module on a 90/30 PLC.

There are various alternate embodiments of the switchboard apparatus 200. For example the apparatus 200 including the controls (consisting of capacitor bus circuit breaker, PQM meter and PLC) reside in the switchboard while capacitors are mounted from a building ceiling adjacent to the switchboard. The capacitors are separately housed with switches and fuses (not shown). In another embodiment of the present invention the capacitors may be installed in switchboard sections for a substantially self-contained switchboard apparatus 200 with power factor correction, as is illustrated in FIG. 2.

The devices discussed above include switchboard 200 which can be, for example, a commercially available low voltage switchboard such as a switchboard from the Spectra Series Switchboards manufactured by General Electric Company of Schenectady, New York. The Spectra Series Switchboards generally have a universal interior that makes it for a family of modular components that provide the flexibility in use to the product line. By utilizing modular assemblies, various modular components can be housed in one or more switchboards. The modular assemblies and uniform and fact connections to the interior allow for ease in maintenance and testing.

Low voltage boards and switchgear assemblies are commonly used in electric power distribution systems such as those typically used to provide power to factories, buildings and commercial installations. Such assemblies are mounted in metal cabinets and include combinations of electrical apparatus for the power distribution systems. The exemplary embodiments of the present invention integrates capacitors and related metering and control equipment into low voltage switchboards for power quality management.

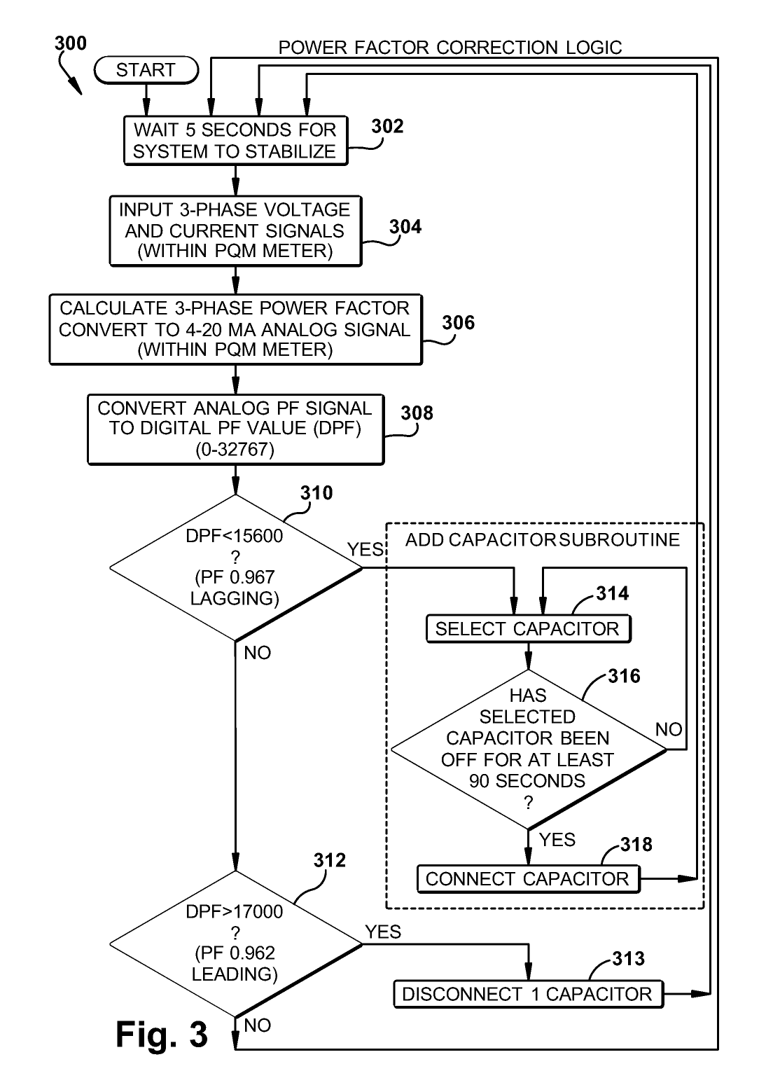

FIG. 3 is a logic diagram for another exemplary embodiment of the present invention. The logic diagram is representative of a specific application but can be modified to represent other switchboard locations where capacitive load is added and dropped in order to maintain power factor of substantially one.

The method is initiated or starts at 300. Next at 302 a 5 second wait is initiated and the switchboard apparatus 200 or system is stabilized. Next at 304 three-phase voltage and current signals are obtained at the PQM. At 306 the PQM calculates three-phase power factor signal and converts the signal to an output in the 4-20 mA range. Next at 308 the PFC analog to digital converter is used to convert the power factor analog signal to a digital power factor value (DPF) in the range of 0 to 32767. A query is made at 310 as to whether the DPF is less than the first predetermined power factor limit, i.e. 15800 (which equates to a power factor of 0.964 lagging). If the answer to query 310 is no, then next at query 312 a query is made as to whether DPF is greater than the second predetermined power factor limit, i.e. 17000 (which equates to a power factor of 0.962 leading). If the answer to query 312 is no, then the method returns to operator 302 and proceeds as previously described. If the answer to query 312 is yes then next at operator 313 a capacitor 214 is disconnected.

The exemplary ranges and upper and lower limits are not meant to limit the present invention and are provided for the purpose of example in explaining the operation of the apparatus of the present invention. One of ordinary skill in the art would understand that the method and apparatus of the present invention could operate with various limits and in various ranges.

Returning to query 310, if the answer to query 310 is yes then an add capacitor subroutine, illustrated inside dotted lines of FIG. 3, is executed. At 314, capacitor is chosen to add. One of ordinary skill in the art can determine which capacitors to add and in what order by considering factors including but not limited to logistics depending upon location of the capacitors. In the present exemplary embodiment one capacitor bank is added in each addition action, then a waiting period is implemented so that the electrical system can stabilize after the addition of the capacitor. Additions of more than one capacitor for another exemplary location can be determined by one of ordinary skill in the art. Next at query 316 a query is made as to whether the selected capacitor has been disconnected from the system for a time at least as long as a time needed to discharge capacitor i.e. has been disconnected for at least 90 seconds. The 90 second disconnect time for this exemplary embodiment allows for the capacitor to discharge to a resistor (not shown). Other discharge times may be determined by one of ordinary skill in the art taking into consideration factors, including but not limited to, the capacitor size. If the answer to the query 316 is no, then the method returns to operator 314, select capacitor and the previously described steps that follow 314 are repeated, as appropriate. If the answer to query 316 is yes, the selected capacitor is connected at 318 via a capacitor connection control signal 215 (see FIG. 2). After 318, the method returns to operator 302 and proceeds as previously described, beginning with operator 302.

It should be noted that in an exemplary embodiment of the present invention, there are up to 16 individual 50 KVAR (KVA reactive) capacitors connected to the switchboard bus 208. The capacitors are connected to the switchboard bus 208 one at a time with a time delay prior to connection. After the time delay, the capacitor 214 are connected to the switchboard bus as needed by energizing switches (i.e. contactors) between the switchboard bus 208 and capacitors 214. Other configurations with varying total numbers of capacitors, different capacitor sizes, and different time delays may be implemented as determined by one of ordinary skill in the art taking into consideration factors including the power factor correction desired at a facility, space available for switchboards, capacitor size and inductive load.

The method of FIG. 3 is for a specific exemplary model of the present invention. The method can be more generic to fit various applications of switchboard apparatus providing power factor correction. The queries 310 and 312 can be changed such that a first predetermined power factor value and a second predetermined power factor value are used in the queries.

By utilizing the above described capacitors and switches, i.e. contacts, in conjunction with PLC(s) and monitoring electronics (i.e. PQM), the substantially self-sustained apparatus samples available power from the utility and compares the available power to a power load side of the electric system. When the power factor falls below a specified point, the PLC signals the contacts to close a circuit that adds capacitive load. The capacitors introduce reactive power to the load, which adjusts the power factor of the load. The apparatus would be protected with breakers and or fuses rated appropriately for the application, as may be determined by one of ordinary skill in the art.

With the advance of electronic components, power factor correction electronics can be configured for use in customer side switchboard packages. Customers could include, for example, residential, industrial, commercial, or any customer with load including transformers, motors, computers, or ballast loads. Correction of power factor reduces overall electric bills for customers; therefore, the use of power factor correction could provide savings equivalent to the cost of the power factor correction equipment in a period of, for example, five years, depending upon the application. The implementation power factor correction on a customer side of an electrical system allows for more efficient use of electricity and less demand on overloaded utility power grids. The energy savings provides benefits to the environment, which is important to today's electric power customers.

In addition to the accomplishment discussed above, this exemplary embodiment of the present invention accomplishes optimizing power consumption while saving customers money. Another advantage is that power factor correction is available to residential, industrial, commercial markets where transformers, motors, computers, or ballast loads degrade power factor.

Yet another advantage to the embodiments of the present invention is that by correcting the power factor, less power losses would result in less power demand from the power supplier (i.e. electric utility).

The aforementioned embodiments of the present invention use an exemplary motor platform that is an AC induction motor. In an alternate embodiment of the present invention a different motor platform that is not an AC Induction motor may be used. One of ordinary skill in the art could determine an appropriate motor platform for the present invention.

It should also be noted that the terms “first”, “second”, “third”, “upper”, “lower”, and the like may be used herein to modify various elements. These modifiers do not imply a spatial, sequential, or hierarchical order to the modified elements unless specifically stated.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A switchboard apparatus comprising:
a switchboard bus comprised of conductors secured to the switchboard apparatus;
at least one capacitor operatively connected to the switchboard bus and electrically in-parallel with the switchboard bus;
a switch operatively connected between the switchboard bus and the at least one capacitor, the switch configured to open and close the at least one capacitor connection to the switchboard bus;
a controller for controlling the switch configured to open and close the at least one capacitor connected to the switchboard bus; and
a power quality device operatively connected to the switchboard bus to obtain power quality and provide the power quality to the controller;
wherein the at least one capacitor is connected to and disconnected from the switchboard bus as a function of the power factor.

2. The switchboard apparatus of claim 1 wherein the switchboard is a low voltage switchboard.

3. The switchboard apparatus of claim 1 wherein the power quality device is a power quality meter.

4. The switchboard apparatus of claim 1 wherein the power quality device is a power quality transducer.

5. The switchboard apparatus of claim 1 wherein the power quality device is connected to the switchboard bus via a potential transformer and a current transformer.

6. The switchboard apparatus of claim 1 wherein the power quality device is connected to the switchboard bus via at least one sensor device.

7. A method of operating a switchboard apparatus on a system comprising:
a) providing the switchboard apparatus connected to the system comprising:
a switchboard bus comprised of conductors secured to the switchboard apparatus;
at least one capacitor operatively connected to the switchboard bus and electrically in-parallel with the switchboard bus;
a switch operatively connected between the switchboard bus and the at least one capacitor, the switch configured to open and close the at least one capacitor connection to the switchboard bus;
a controller for controlling the switch configured to open and close the at least one capacitor connected to the switchboard bus; and
a power quality device operatively connected to the switchboard bus to obtain power quality and provide the power quality to the controller;
wherein the at least one capacitor is connected to and disconnected from the switchboard bus as a function of the power factor.
b) providing a first predetermined power factor limit as a lower limit for the power factor of the system;
c) providing a second predetermined power factor limit as an upper limit for the power factor of the system;
d) determining the power factor of the system;
e) comparing the power factor of the system to the first predetermined power factor limit and the second predetermined power factor limit;
f) connecting, using the switch configured to open and close the at least one capacitor, one of the at least one capacitor operatively connected to the system, if the power factor of the system is below the first predetermined power factor limit;
g) disconnecting, using the switch configured to open and close the at least one capacitor, one of the at least one capacitor operatively connected to the system, if the power factor of the system is above the second predetermined power factor limit.

8. The method of claim 7 further comprising:
h) determining, after e) and before f) if the one of the at least one capacitor connected to the system has been disconnected from the system for a time at least as long as a time needed to discharge the of the at least one capacitor operatively connected to the system.
